(19) United States
(12) Patent Application Publication
(10) Pub. No.: US 2002/0024214 A1
(43) Pub. Date: Feb. 28, 2002

(54) Postal stamps and stickers for flyers

(76) Inventor: Thomas E. Wagner, St. Louis, MO (US)

Correspondence Address: PAUL M. DENK, 763 South New Ballas Rd., St. Louis, MO, 63141, US

(21) Appl. No.: 09/923,016

(22) Filed: Aug. 6, 2001

Related U.S. Application Data
(60) Provisional application No. 60/223,720, filed on Aug. 8, 2000.

(51) Int. Cl. B42D 15/00

(52) U.S. Cl. 283/71

(57) ABSTRACT

Postal stamps and flyer stamps, which may include a lower surface, one for imprinting with the usual postage stamp, while the other may be imprinted with advertising material, both of which have upper extending segments, separated by a perforated or otherwise fold line, for use for attachment to the upper free edge of a flyer, folded over to seal it into closure.

### CROSS-REFERENCE TO RELATED APPLICATION

This application is a regular letters patent application based upon the provisional application having Ser. No. 60/223,720, filed on Aug. 8, 2000.

### BACKGROUND OF THE INVENTION

For centuries, the Postal Service has supplied stamps to the public for mailing various classes of mail on behalf of its citizens and the public. Obviously, the stamps are applied to envelopes, cards, and the like. Of more recent years, perhaps the last three decades, the postal meter has been available to forward postage.

For many years, the three-fold, but perhaps multi-fold flyers, usually of 8½ inch by 11 inch dimension, when unfolded, have been mailed using stickers to attach the bottom corners of the flyers, for mailing, and to reduce them, usually when folded in thirds, to letter size. The first-class stamp was then attached to the upper right-hand corner of the folded flyer, for mailing. By this method, the mass merchandisers, particularly through the use of the postal services, could avoid the use of envelopes, and the substantial labor required to seal it, when circulating such flyers through the mail to voluminous recipients.

### SUMMARY OF THE INVENTION

This current invention contemplates the preparation of the usual three-fold flyer, for mailing, but providing an adaptation that can reduce the labor involved, while simultaneously furnishing means for mailing, to the public. This current invention, identified as a flyer stamp, would provide for the three fold of the standard flyer, into the reduced size, but the flyer is then sealed at the top, utilizing the particular stamp of this invention, to seal it into closure. In the preferred embodiment, the flyer stamps include the usual stamp, and then having a fold line provided at its upper edge, such as formed through perforation, and includes a blank or otherwise upper extended portion, which may be folded over the upper edge of the three-fold flyer, to thereby seal it into closure. This flyer stamp could be applied to the central upper edge of the folded flyer, or at the upper right edge, where stamps are normally applied. In addition, where the flyer stamp is applied to the upper right of the flyer, the postal service could also form a postal sticker, similar in appearance to the previously identified stamp, but not require the use of a stamp, and which could be printed with other indicia, such as advertising, or advertising on behalf of the public, and be applied to the upper left edge of the three-fold flyer, and having its upper extended portion folded over, about its perforated line, to secure and seal the folded flyer at two locations, along the top edge, into closure, in preparation for mailing. These stamps and stickers can be either moisture adhered or pressure applied.

Essentially, through the usage of this invention, the customer need only use a single step, or perhaps two steps, in preparing a three-fold flyer for mailing. Instead of having to apply stickers to the bottom edge of the flyer, to seal it into closure, and then apply a stamp at the upper right corner, in this particular instance, where the opening edge of the flyer is located at the top edge of the three-fold flyer, only a single flyer stamp, or a flyer stamp with a postal sticker, need be applied to the upper edge, folded over its perforated line into closure, to seal the upper edge in preparation for mailing. With flyer stamps, the flyer is simply sealed at the top using the stamp itself, and one of the identified postal stickers, which may be formed of a similar configuration as a stamp, but contain the type of advertising or other indicia as explained. This saves the customer one step, that is, requires the customer only to attach a stamp at the upper edge, in a one-step process, and fold it over to secure the flyer into closure. Or, additional such means for sealing may be applied to the upper edge, as explained, utilizing one of the flyer stamps, and one of the other advertising postal stickers, along the top edge, to seal the flyer into closure. By doing this, the user accomplishes two tasks at one time, which applies both the postage and the sealing means at the same time, rather than requiring the separate application of postage, and the separate sealing of the edges of the flyer, through two different tasks. Though this manner, and through use of the flyer stamps of this invention, the postage will already be applied, and additionally, the postal customer does not have to shop for other stickers to attach to flyers, to seal them. In addition, the bulk rate, or postage paid permit customer, may find it more desirable to just buy flyer stamps, in addition to the postal stickers, as required.

It is, therefore, the principal object of this invention is to provide combination postal stamps and stickers for securement and containing three-fold or other styled flyers into closure.

Another object of this invention is to provide for the use of stickers, for automatically applying postage, to circulars mailed through the postal service.

A further object of this invention is to provide for the design of flyer stamps, in addition to postal stickers, which may be marketed by the Post Office, and even generate some remuneration for it, through the sale of advertising to the postal stickers to the public and trade.

These and other objects may become more apparent to those skilled in the art upon review of the summary of the invention as provided herein, and upon undertaking a study of the description of its preferred embodiment, in view of the drawings.

### BRIEF DESCRIPTION OF THE DRAWINGS

In referring to the drawings, FIG. 1 discloses a three fold flyer, with one of the flyer stamps, and one of the postal stickers, in the process of being applied to its upper edge;

FIG. 2 discloses how the flyer stamps, and/or the postal stickers, may be sold in rolled dispensers to the market;

FIG. 2A is a sectional view through the dispenser of FIG. 2;

FIG. 3 is a front view of an envelope or folded flyer showing the use of one of the stickers and stamps of this invention for sustaining closure;

FIG. 4 is a back view of the envelope or flyer of FIG. 3 showing the folded over sticker and the sticker portion of the stamp for holding the item in closure;

FIG. 5 shows an envelope or flyer secured in closure by means of one of the postal stamps of this invention;

FIG. 6 is a back view of the article shown in FIG. 5, showing the sticker portion of the stamp;

FIG. 7 shows how the modified postal stamp of this invention can be marketed in sheet form, the postal stickers capable of being marketed in the same manner; and

FIG. 8 shows how the postal stamps of this invention may be sold in multiple sheets along with sheets of the postal stickers of this invention.

### DESCRIPTION OR THE PREFERRED EMBODIMENT

In referring to the drawings, in FIG. 1, the three-fold flyer, as noted at 1, is shown folded over having its upper free edge 2 disposed just in that manner, upwardly, for application of a flyer stamp 3 applied thereto. The stamp portion of the flyer stamp, as at 4, will be arranged sealed to the front surface, as at 5, of the flyer, while the upper edge of the flyer stamp, as at 6, may be folded over about its line of perforation, as at 7, or along its fold line, for use for sealing the upper edge 2 of the flyer into closure. In this manner, one of the flyer stamps 3 could be applied at the usual position required for postage, the upper right hand corner of the flyer, or perhaps the postal authorities could arrange for the application of a single flyer stamp at the center of the flyer, and still comply with regulations requiring postage to be applied to anything sent through the mails. Of, in the alternative, one of the postal stickers 8 of this invention could be applied to the upper left hand corner of the flyer, folded over about its perforated or fold line 9, and have its upper extending edge as at 10, folded down for sealing against the back side of the flyer, to hold it into closure. The postal sticker, along its front surface 11, could contain advertising, or any other indicia, at the desire of the postal authorities, or the Postal Service could even sell advertising to the public, as a means of commerce, to raise money for the postal authorities, in this manner.

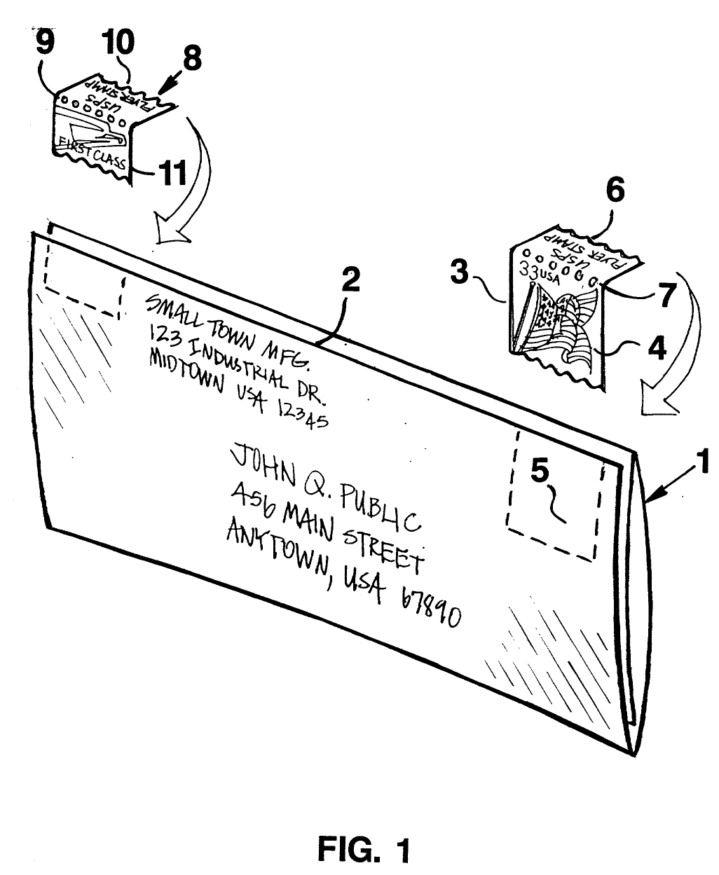

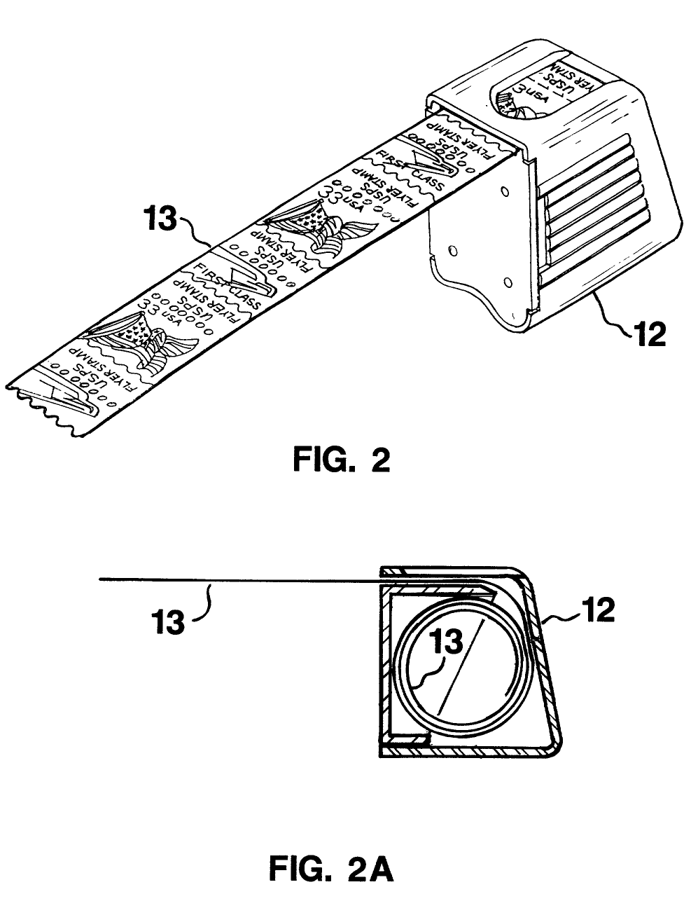

As can be seen in FIGS. 2 and 2A, the usual type of dispenser 12 could be used for selling the flyer stamps, as can be seen at 13, or such a dispenser could also be used for marketing the postal stickers, in the same manner. Or, perhaps such a dispenser could dispense both flyer stamps and postal stickers simultaneously, in alternating sequence of such types of stamps and stickers, ready for pulling free, and usage for application to a tri-fold flyer, as desired.

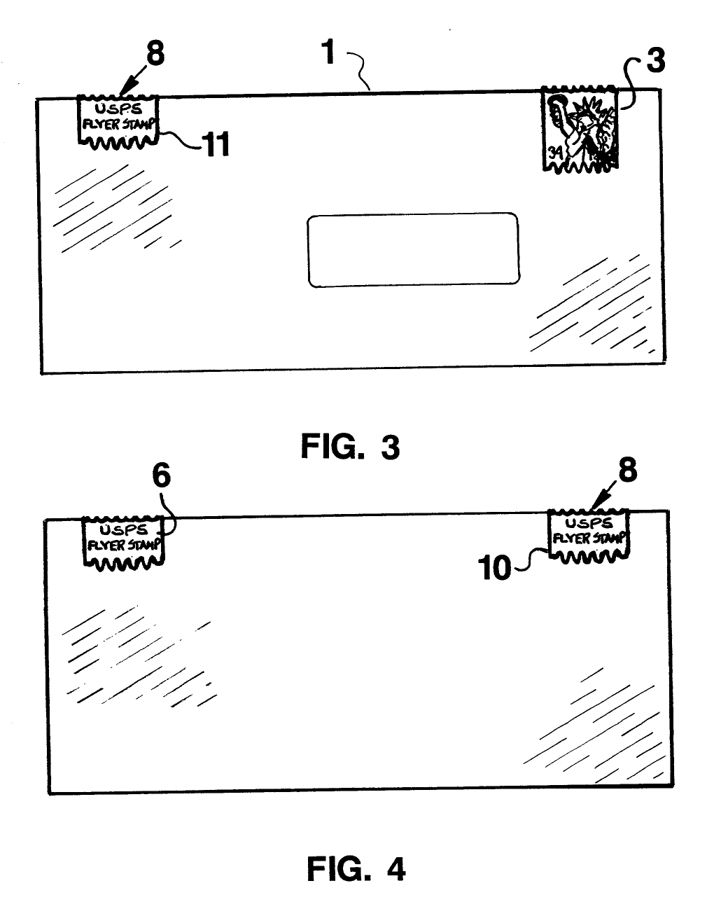

FIG. 3 discloses one of the tri or bi fold flyers 1 and shows how one of the postal stamps 3 is sealed to the front surface of the flyer, with its sticker portion 6 adhering to the back surface, to hold the flyer or envelope in closure. See also FIG. 4. In addition, these figures disclose how the unique type of postal sticker 8, as previously explained may adhere to both the front and back pages of the flyer, or the envelope, by means of its fold over portions 10 and 11, to adhere the folder into closure, as can be understood.

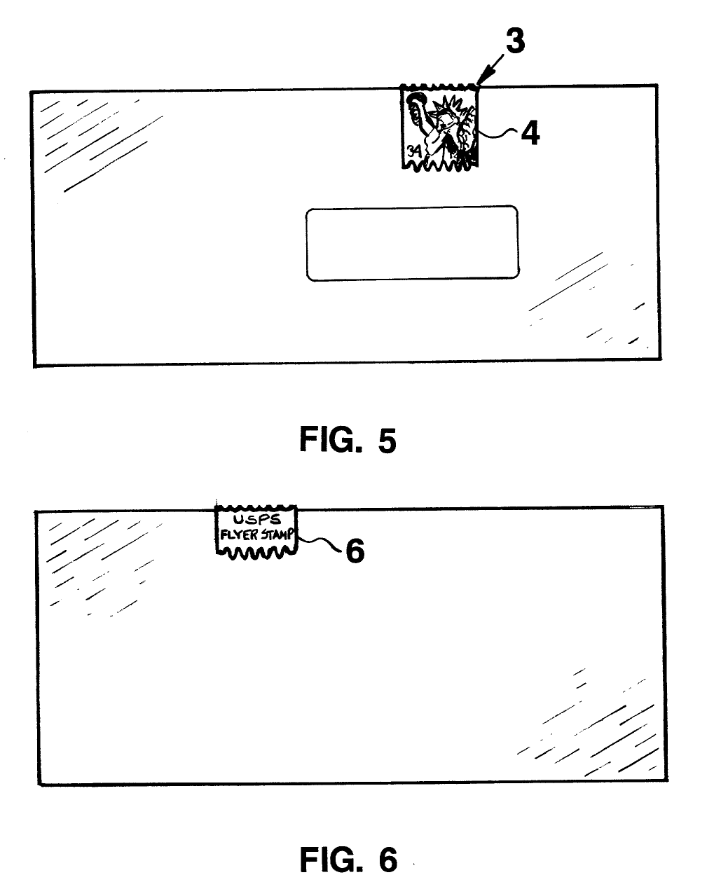

FIGS. 5 and 6 disclose how a singular of the postal stamp 3 of this invention can be adhered to both the front surface of the flyer, as noted in FIG. 5, and then have its sticker portion 6 folded over for adherence to the back side of the flyer or envelope, as noted in FIG. 6.

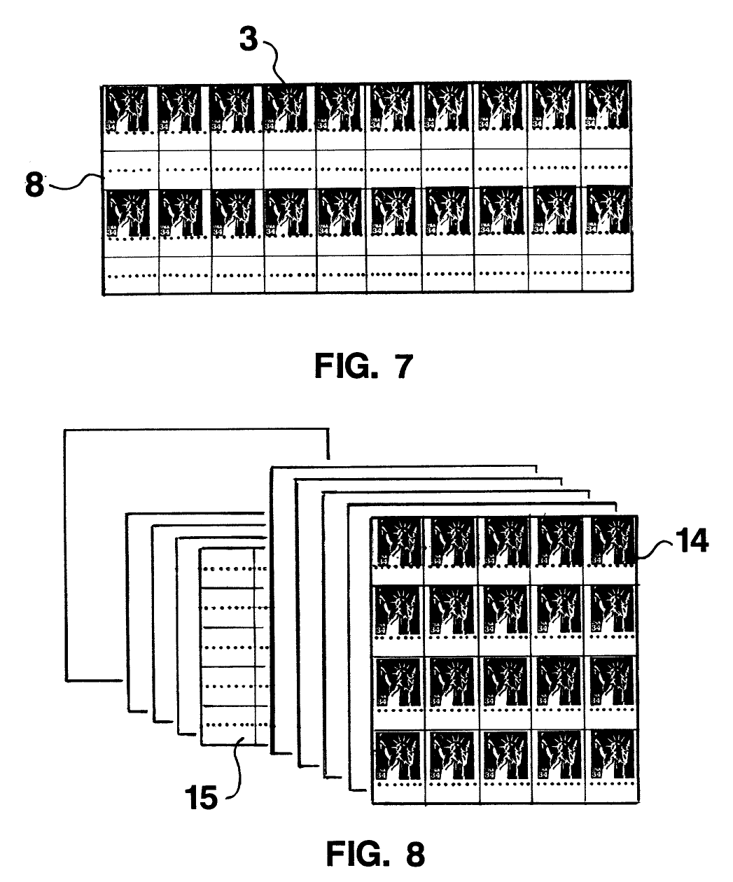

FIG. 7 shows how the prior stamps 3 could be sold in one or more rows for a sheet of stamps, while the postal stickers 8 can be sold underneath thereof, both said stamps and postal stickers being attached into a singular sheet, prepared for marketing as sheets of combined stamps and stickers as can be understood. In addition, as can be seen in FIG. 8, this shows how the complete sheets of postal stamps, as at 14, can be marketed, in addition to sheets of postal stickers, as at 15, could be marketed similarly, in combination, for use for the purposes of this invention.

These are examples are of how the concept of this invention, for use upon usually three-fold flyers, could be enhanced through the use of the flyer stamps of this invention, while simultaneously providing to the user postal stickers, in the manner as explained herein.

Variations or modifications to the subject matter of this invention may occur to those skilled in the art upon reviewing the disclosure as provided herein. Such variations, if within the scope of the development as described herein, are intended to be encompassed within the scope of this invention. The illustrations and description of the preferred embodiments, as set forth herein, are done for illustrative purposes only.

1. A combination postal stamp and sticker, the postal stamp and sticker being foldably connected together along contiguous edges, said postal stamps and its foldable sticker for use for adhering an envelope or flyer into closure for mailing and delivery, said postal stamp being imprinted with postal stamp indicia acceptable for transfer through the mails, while the sticker portion capable of folding over, for adhering the foldable flyer or envelope into closure during mailing.

2. The postal stamp of claim 1 wherein said postal stamp and sticker portion are separated by a line of perforation to form a fold line intermediate thereof.

3. The postal stamp of claim 2 wherein said foldable postal sticker being imprinted with indicia.

4. The postal stamp of claim 3 wherein said printed indicia may include advertising.

5. A postal sticker, said postal sticker being formed of two parts, said parts being foldably connected together along contiguous edges, said postal sticker for use for adhering an envelope or flyer into closure for mailing and delivery, said postal sticker on its two parts being imprinted with indicia acceptable for transfer through the mails, with both said sticker portions capable of folding over for adhering a foldable flyer or envelope into closure during mailing.

6. The postal sticker of claim 5 wherein said first and second postal sticker portions are separated by a line of perforation to form the fold line.

7. The postal sticker of claim 6 wherein said first and second foldable postal stickers include a surface capable of accepting indicia.

8. The postal sticker of claim 7 wherein said indicia may include advertising material.

9. The postal stamp of claim 1 wherein said stamps and stickers are provided in roll form, and a dispenser capable of holding a roll of said postal stamps and stickers to provide for their dispensing.

10. The postal stamp of claim 1 wherein said postal stamps and foldable sticker are provided in sheet form.

11. The postal sticker of claim 5 wherein a series of said postal stickers are provided in roll form.

12. The postal stickers of claim 11 and including a dispenser for holding a roll of the postal stickers for use for dispensing of said stickers.

13. The postal stamp of claim 10 wherein said postal stamps are provided adjacently along one or more rows in the sheet form, while said foldable stickers are provided adjacently below the rows of postal stamps.

14. The postal stamp of claim 1 wherein said postal stamps and foldable stickers are provided in roll form, said postal stamps and foldable stickers being alternately provided in the roll form for alternate dispensing of postal stamps and postal stickers during usage.

15. The postal stamp and sticker of claim 14 and including a dispenser, and wherein said postal stamps and postal stickers are dispensed from said dispenser in the roll form.
